(19) United States
(12) Patent Application Publication
(10) Pub. No.: US 2014/0033167 A1
(43) Pub. Date: Jan. 30, 2014

(54) METHOD AND SYSTEM FOR GENERATING A MANIFESTATION OF A MODEL IN ACTIONSCRIPT

(71) Applicants: Edward Solovey, Brookline, MA (US); Basil C. Hosmer, Winchester, MA (US)

(72) Inventors: Edward Solovey, Brookline, MA (US); Basil C. Hosmer, Winchester, MA (US)

(73) Assignee: Adobe Systems Incorporated, San Jose, CA (US)

(21) Appl. No.: 12/550,225

(22) Filed: Aug. 28, 2009

(51) Int. Cl. G06F 9/44

(52) U.S. Cl. 717/104; 717/108

(57) ABSTRACT

Computer-based methods and systems for generating script-based code, based on a model, are described. Consistent with an embodiment of the invention, a software development application includes a code generator module that receives a model. The code generator module processes the model to generate script-based code. Specifically, the script-based code includes a value object class for each model entity defined in the model, and a service wrapper object class for each service element defined in the model. The value object classes support both basic and advanced data modeling capabilities and corresponding data operations. The service wrapper object classes provide a remote service capability, enabling the client application to communicate with remote services implemented on an application server.

### TECHNICAL FIELD

The present disclosure generally relates to model-driven software development tools. More specifically, the present disclosure relates to methods and systems for generating a script-based manifestation of a model, for use in a client-side portion of an application.

### BACKGROUND

A model-driven software development technique is a development methodology in which models, or abstractions, are utilized to implement a software application. For example, utilizing a model-driven software development tool, a software developer may develop a graphical or text-based model of a software application. The model is then provided as input to a code generator, which analyzes the model and generates application code for a target platform based on the model.

A variety of problems exist with conventional model-driven software development tools. First, many conventional model-driven software development tools only generate code that performs a subset of the fully realizable functionality associated with a particular target application framework and/or platform. For instance, many model-based development tools only support generating code that performs the most basic of data operations. This leaves the software developer with the option of foregoing more advanced data operations, or manually coding the more advanced data operations. Similarly, some tools only generate client-side code (or, server-side code) based on a model, leaving the software developer to manually generate the server-side code (or, client-side code). Furthermore, with many model-driven software development tools, it is difficult if not impossible to preserve any code customization when a model is manipulated, and redeployed.

### DESCRIPTION OF THE FIGURES

Some embodiments are illustrated by way of example and not limitation in the figures of the accompanying drawings, in which:

FIG. 1 is a functional block diagram of a model-driven software development environment including a model-based software development application with a code generating module executing on a first computer system, consistent with an embodiment of the invention;

FIG. 2 is a block diagram showing the inputs and outputs of a code generating module of a model-based software development application, according to an embodiment of the invention;

FIG. 3 illustrates an example of a method, according to an embodiment of the invention, for generating client code; and

FIG. 4 is a block diagram of a machine in the form of a computer system within which a set of instructions, for causing the machine to perform any one or more of the methodologies discussed herein, may be executed.

### DETAILED DESCRIPTION

Methods and systems for generating a script-based manifestation of a model, for use in a client-side portion of an application, are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

Consistent with an embodiment of the invention, a code generating module of a model-driven software development application generates a script-based manifestation of a model. This manifestation (e.g., script-based code derived from the model) consists of generated value object classes corresponding to entities defined in the model, and service wrapper classes corresponding to model services defined in the model. Accordingly, with a complete and annotated model, the code generating module enables an application developer who is not familiar with a particular scripting language, to generate the base of their client-side application from the model. In some embodiments, the entirety of the infrastructure on which the user interface (UI) is built atop is generated by the code generating module. Accordingly, with some embodiments, the only client-side part of the application that may not generated by the code generating model is the actual UI forms, panels, grids, and so on.

In some examples described herein, the script-based code is specifically described as being consistent with ActionScript. However, in various alternative embodiments, the script-based code generated by the code generator module may be another form of ECMAScript, such as JavaScript, or Jscript, or even a non-ECMAScript. In any case, the generated value object classes provide a script-based manifestation of both basic and advanced modeling concepts, corresponding to basic and advanced data operations. The basic modeling concepts and data operations involve data properties with a pair of accessor/mutator methods (e.g., getters and setters)—concepts well known to those skilled in the art of object oriented programming. As such, in some respects the value object classes behave much like conventional JavaBeans, which also use getters and setters.

However, in contrast to many conventional model-driven software development tools, embodiments of the invention support advanced modeling concepts and corresponding data operations involving derived properties, varying properties, constraints, and styles. In addition, the value objects that are instantiated from the generated value object classes utilize an event framework to provide a complete implementation of these advanced concepts and operations. In some embodiments, the event framework is part of the Adobe Flex® software development kit, developed by and available from Adobe Systems, Inc. of San Jose, Calif. Utilizing the event framework, certain events (e.g., a change made to a data value stored in a relational database on a server) can be detected and trigger certain actions, such as re-computing a derived property. The combination of the event framework and the generated script-based code results in a full manifestation of the model, thereby relieving application developers from the arduous task of having to manually translate the advanced modeling concepts into script-based code.

In addition to providing support for advanced modeling concepts and data operations, the modeling framework and code generator module are capable of generating service wrapper classes based on model services defined in the model. Accordingly, these service wrapper classes provide the “plumbing” to enable the application derived based on the model to connect to various remote services. In some embodiments, three standard remote services are supported, including a web service, a remote object service, and an HTTP service. Accordingly, by simply annotating a service element in the model, an application developer can create a service that corresponds to any one of the three remote services. In addition, a model service may be annotated to provide a customized service. Other inventive aspects will be readily apparent from the description of the figures that follow.

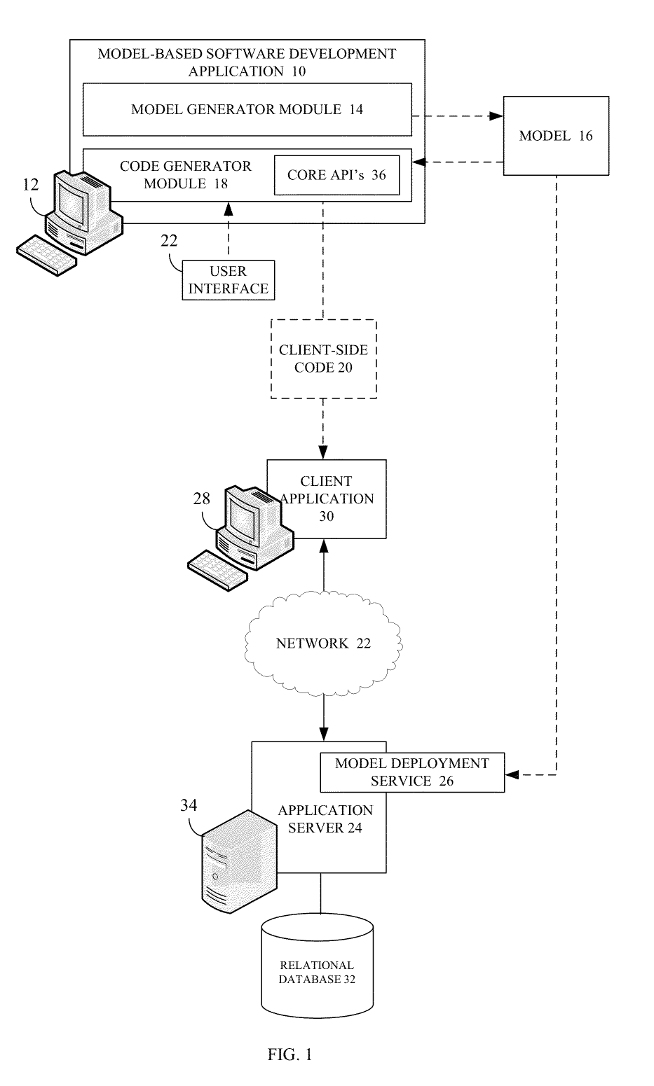

FIG. 1 is a functional block diagram of a model-driven software development environment consistent with an embodiment of the invention, including a model-based software development application 10 executing on a computer system 12. In general, an application developer utilizes the model generator module 14 of the software development application 10 to generate a model 16 for a model-based application. After generating the model 16, the model 16 can be automatically deployed, for example, by invoking the code generator module 18 to generate, based on the model, client-side code 20 for the application. In some embodiments, the generated model 16 is utilized to generate both the client-side application code and the service-side application code. For example, when generating the client-side application code 20, the code generator module 18 may receive as input both the model 16 and a user interface component 22. To generate the server-side code, the model 16 may be communicated to an application server 24, where a model deployment service 26 processes the model, fully configures the application server 24, and generates the necessary server-side code, based on the model 16.

Once the generated client-side code 20 is installed and executed on a client computer 28, the client application 30 can communicate with the application server 24 by invoking a remote service object, instantiated based on a service wrapper object class generated from a service element defined in the model. Furthermore, certain events happening on the application server 24, such as a change to a particular data value in the relational database 32, will trigger actions at the client application 30. For example, a data update operation to a data element persisted in the relational database 32 may cause, via an event framework, a derived property of a value object to be recomputed, ultimately causing a user interface element that is bound to the derived property to be manipulated. The relationships expressed in the model make all this possible.

As illustrated in FIG. 1, the model-based software development application 10 includes both a model generator module 14, for generating and editing models, as well as a code generator module 18, for automatically generating script-based code, based on a model 16. In some embodiments, the model-based software development application 10 may be a version of Adobe® Flex® Builder™, which is itself based on the Eclipse™ integrated development environment (IDE). However, in alternative embodiments, other software development applications might be used. In FIG. 1, the model generator module 14 and the code generator module 18 are shown to be part of the same software development application. In some embodiments, the model generator module 14 and the code generator module 18 may be plug-in modules, which are integrated with the IDE via an application programming interface (API). Alternatively, in some embodiments, the model generator module 14 and the code generator module 18 may be separate stand-alone applications.

In general, the model-based software development application 10 enables an application developer to generate and edit a model 16, and ultimately to generate script-based code and deploy an application, based on the model 16. For instance, in some embodiments, the software development application 10 includes a graphical user interface element (e.g., a button, or menu item) that allows an application developer to automatically invoke the code generator module 18, and in some instances, deploy the model to the application server 24.

As used in FIG. 1, the term “application server” 24 refers to the various software components comprising the application server framework, for example, residing and executing on the server computer (with reference number 34). In one embodiment, the application server 24 may be a version of Apache Tomcat, an open source software implementation of the Java Servlet and JavaServer Pages technologies. In some embodiments, the application server may include a data management tier (not shown), including a web application implemented with a version of LiveCycle Data Services, developed by, and available from, Adobe Systems, Inc. of San Jose, Calif. However, skilled artisans will readily recognize that the terms “application server”, “application server framework” and “data management tier” generally refer to the software framework that is utilized to expose application logic (e.g., business logic) to web- or network-based client applications, often through the use of an application programming interface (API). Moreover, although not necessarily the case, application servers are frequently Java-based (e.g., based on Java Platform, Enterprise Edition, or Java EE). Thus, although example embodiments may be described in the context of an application server based on Tomcat and LiveCycle Data Services, the inventive concepts described and claimed herein are applicable to a wide variety of application servers, server frameworks, and web applications, beyond those that might specifically rely on implementations of Tomcat, LiveCycle Data Services, and Adobe Flex®.

In the context of the present disclosure, the model 16 is an abstract structure that describes how data is represented and accessed, by the client application 30 and at the application server 24. The model 16 is broadly similar in scope and granularity to a relational database schema, in the sense that it defines an interrelated set of structured data collections, and provides the means to express specification at structure, collection, and relationship scales. The model defines entities (e.g., model entities and services, or service entities), which are abstract interrelated data objects. Model entities represent custom data types and are made up of data elements referred to as data properties, which correspond to persistent storage, and derived properties, which are not backed by persistent storage and enable behavior customization in expressions over data properties and function calls. A model also defines abstract service entities that represent services responsible for delivering model entities to and from clients. Service entities declare collections of functions, external callable endpoints that can be invoked within value expressions. Consistent with some embodiments of the invention, in addition to entities and services, definitions found in the model 20 include styles, which bundle user-interface-related information with data types, and annotations, which enable an application developer to add domain-specific information to a model.

In some embodiments, the model is an XML-based language that allows an application developer to define model entities, the relationships between those entities, and abstract services responsible for delivering the model entities to data clients. In some embodiments, the modeling language works in conjunction with a set of Java-based API's, referred to as the core API's 36, that process and validate the content of the models and can also generate concrete application code (e.g., ActionScript), based on the model. For example, the core modeling API's, which are shown to be part of the code generator module 18 in FIG. 1, provide built-in support for generating the following:
Script-based (e.g., ActionScript, JavaScript, JScript) objects that represent model entities and service entities for calling data services from a client application.
Java-based objects that represent model entities, the relationships between those entities, and services on an application server or client. The generated services can make queries to database tables that correspond directly to the entity elements in the model.
   Consistent with some embodiments of the invention, script-based client code and Java-based server code can be generated from the same model that maps to a SQL database. Consequently, an application developer can rapidly create a functional client application that calls an application server destination and manipulates data in a SQL database.

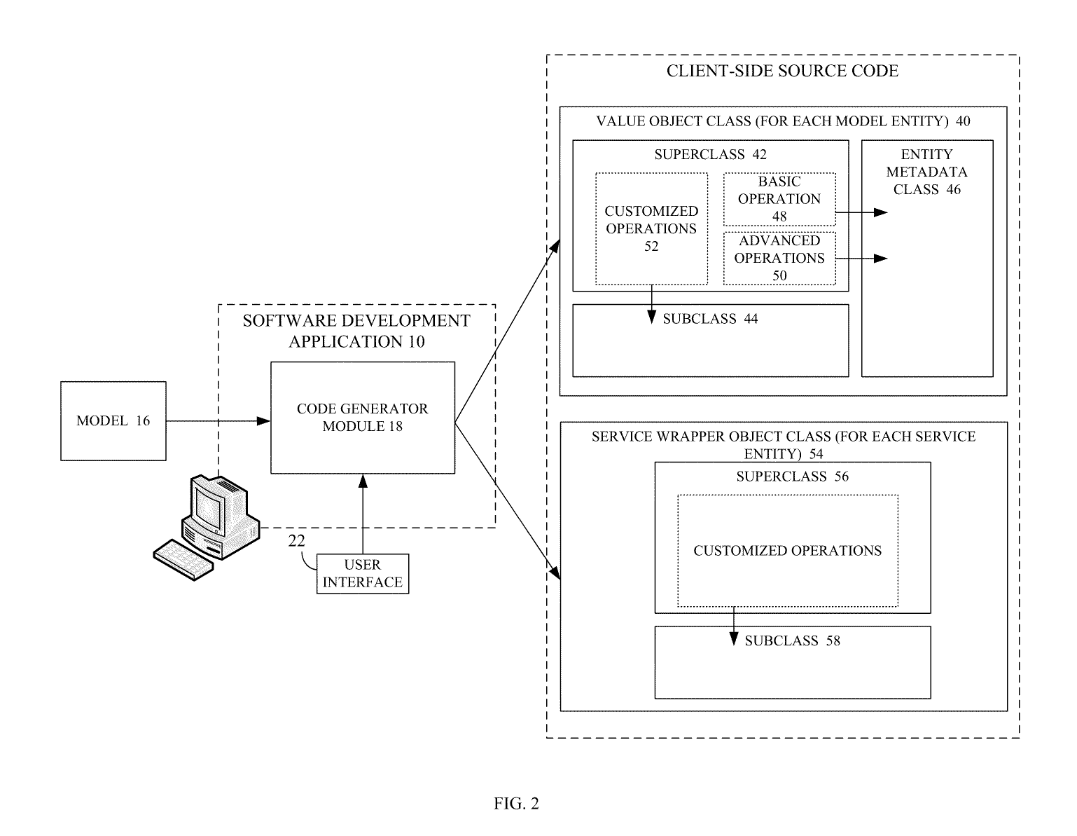

FIG. 2 is a block diagram showing the inputs and outputs of a code generating module 18 that provides a script-based code generating service for a software development application 10, according to an embodiment of the invention. As illustrated in FIG. 2, the code generating module 18 receives as input a model 16. In some instances, the code generator module 18 may also receive as input a user interface component 22. Alternatively, in some embodiments, the user interface component 22 may not be presented as an input to the code generating module 18, but instead, may be manually added or integrated with the output of the code generator module, during compile time. In some embodiments, a basic UI is generated based on the model itself. This basic UI can then be manually adapted to the developer's requirements.

When invoked to operate on a particular input model, the code generator module 18 analyzes and processes the model to generate script-based code. In some embodiments, the code generator module 18 may first validate the model by analyzing the model to ensure that it conforms to the proper format requirements, and so forth. Next, for each model entity processed, the code generator module 18 generates a value object class 40 consisting of a superclass 42, subclass 44 and entity metadata class 46. In general, the superclass 42 defines the data properties and corresponding functions or methods associated with the basic data operations 48 and advanced data operations 50. The subclass 44 provides the actual logic for the functions associated with the basic data operations and advanced data operations. Accordingly, the value object subclass 44 allows developers to customize the behavior of the value object 40 by overriding any of the functions of its superclass 42. Every time that code is generated from the model, the superclass 42 is regenerated. However, the subclass 44 is only generated if it does not already exist. This ensures that functions that were overridden by developers, and thus customized, do not get overridden with each regeneration cycle. This allows a model designer to evolve the model and regenerate the script-based code (e.g., ActionScript code) to account for model changes without destroying the customizations put in place by application developers.

The entity metadata class 46 contains the logic for the calculations or functions described in the superclass 42. This allows the actual value object superclass 42 to remain light weight and rely on the associated entity metadata class 46 for all complex calculations. This is generally advantageous because there will frequently be many instances of the value object class flowing through the system at runtime.

As illustrated in FIG. 2, the code generator module 18 generates a service wrapper object class for each service element defined in the model. Services are represented as service wrapper object classes in script-based code. Each service wrapper will have a public function for every function declared for the service in the model. In some embodiments, the arguments to the function are strong types based on their types in the model. Function arguments declared to be of an entity type in the model will be represented as value object types, as discussed above.

Service wrappers follow the same generation strategy as the value objects (described above). A superclass 56, and subclass 58 are generated for each service. The superclass 56 has all of the configuration, setup, and invocation logic specific to the service. The subclass 58 allows developers to override functions and provide customizations 58. As above, the superclasses are regenerated during every regeneration cycle and the subclasses are only generated once, ensuring that user customizations are preserved across model evolution.

In some embodiments, the services represented by the service wrapper object classes will leverage an application framework (e.g., the Adobe Flex Software Development Kit) to support certain types of remote services, such as web services, remote object services, and HTTP services. When service declarations are annotated within the model as one of these three services, and have additional annotations to provide server connection information such as Web Service Definition Layer (WSDL) Universal Resource Identifier (URI), remote endpoint URI, or hypertext transfer protocol (HTTP) URI, the service wrappers provide predefined, strongly typed communication objects for these services.

In some embodiments, when a model service declaration is not annotated as a known type (e.g., one of the above three types), it is assumed to be a custom service. In such a scenario, the superclass 56 will still contain strongly typed function signatures but it will remain up to the application developer to implement the actual invocation logic in the subclass 58.

The value objects and service wrapper objects derived from the generated classes interact in two different ways. First, when a derived property of a model entity involves a service function call, the generated calculator function for that data property will involve the instantiation of a service wrapper object and a service invocation to perform that calculation. When model entities appear in function signatures, the service wrapper function declarations for these operations will reference value object classes generated to represent the entities.

As briefly described above, in some embodiments, some of the advanced modeling and data operations supported via the modeling framework include: derived properties, varying properties, constraints, and styles. A brief description of each follows.

A derived property is a value expression involving one or more other data properties, or derived properties, of the entity. In some embodiments, for each derived property, there exists a bindable getter function. A private field to store the current value of each derived property and a calculator function to compute the value of each derived property are used to keep derived property values current. In some embodiments, from the model it is possible to determine which data properties may impact the value of a derived property. Whenever any of these data properties change, re-calculation of all derived properties that depend on the data property is triggered. Since derived property getters are bindable, any UI component displaying a derived property value is automatically updated when that value changes.

A variant property describes a part of the model entity for which the structure varies in a precise way. Structurally, a variant is similar to the switch construct available in many programming languages. An expression associated with the variant property, called a selector expression, produces a value which is used to select among a collection of children, with an optional default value available if none of the explicitly specified keys matches the current value of the selector expression. However unlike a switch, which selects a block of code to run, a variant selects a data substructure from a set of possible choices. This substructure only exists when the model entity instance is in a state that produces the specified selector value.

In some embodiments, both data and derived properties may appear inside variant properties. In addition to the data or derived properties API's described above, a bindable, Boolean property will be exposed for each varying property. In some embodiments, this bindable Boolean property's value will be true whenever the variant state is such that the varying property exists. The Boolean value will be false when the varying property's state is such that the property does not exist. Accordingly, application developers (particularly, user interface designers) may have their UI components bind their visible attributes to these properties to easily adjust their UI for varying properties. The model includes all of the information needed to keep these Boolean existence properties up to date as the data properties that they depend on change.

In some embodiments, a constraint is a Boolean-typed derived property whose value constrains the data state of a model entity instance. The model entity instance is not valid unless the constraint's value evaluates to true. Accordingly, in some embodiments, the set of constraints along with the set of all style validations (described below) determine the validity state of a model entity instance. Each value object is configured to expose a bindable, Boolean validity property that will be true whenever the instance is in a valid state and false when it is not. In addition, the value object is configured to expose a bindable, array property that will contain all of the localized constraint and validation failure messages when the value object is in an invalid state. Similar to derived properties (described above), this array will be automatically kept up to date based on the dependence information extracted from the model.

Finally, in some embodiments, a style element defines a style available within a model. A style is a collection of user-interface-related attributions that can be associated with a property element in the model. Styles allow application developers, or modelers, to provide localization information, such as property level validations (as opposed to model entity level validations, referred to as constraints), and masking (edit and display) of information. Locacalization information is made available via per property, bindable, style getters. UI designers may bind attributes such as labels, and hover text to these getters and their UI will automatically be localized and stay in sync with value object state (styles may contain expressions and may themselves vary with variant state). The validation aspect of styles is accounted for in the Boolean validity property described above, as well as the array collection of constraint/validation failure messages described above. In addition, per property bindable, Boolean validity getters and bindable, array collections of failed validation messages are exposed.

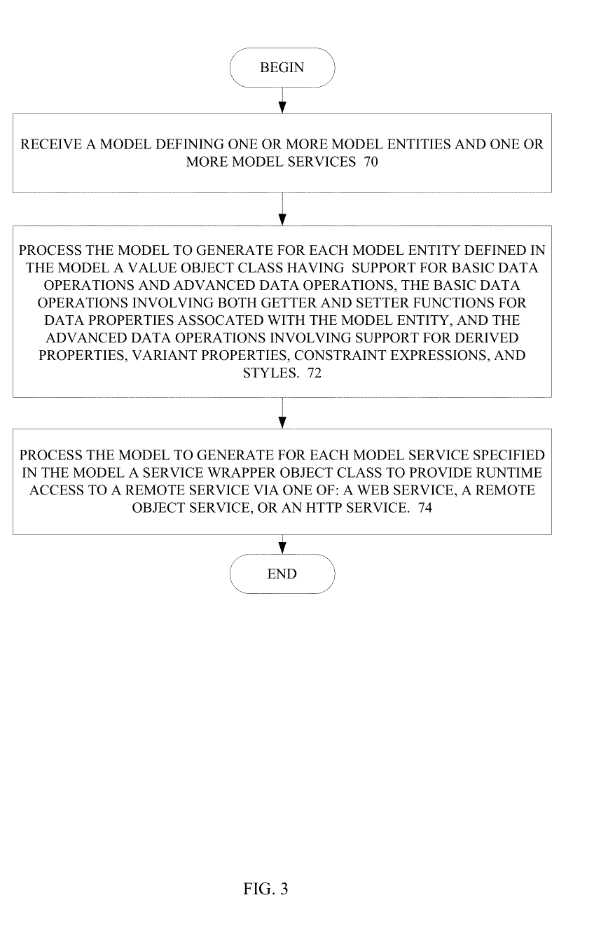

FIG. 3 illustrates an example of a method, according to an embodiment of the invention, for generating client code. The method begins when an application developer invokes a code generator module to generate script-based application code, based on a model. Accordingly, at method operation 70, the code generating module receives a model defining one or more model entities and one or more model services, or service entities. The code generating module may optionally validate the model, for example, by ensuring that the model conforms to a pre-specified format.

Next, at method operation 72, the model is processed to generate script-based code. Specifically, for each model entity defined in the model, a value object class is generated. The value object class may have the general structure as shown in FIG. 2. In any case, the value object class represents a script-based manifestation of the model that supports both basic and advanced data operations. The basic data operations involve data properties, and the setter and getter functions for operating on the data properties. The advanced data modeling and operations supported by the value object class include derived properties, variant properties, constraint expressions and styles.

In addition to generating value object classes for each model entity, at method operation 74, the code generating module processes the model to generate a service wrapper object class for each service defined in the model. The service entities provide support for a remote service, including web services, remote object services, and an HTTP service.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. Accordingly, the modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or as a service, for example, such as in the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

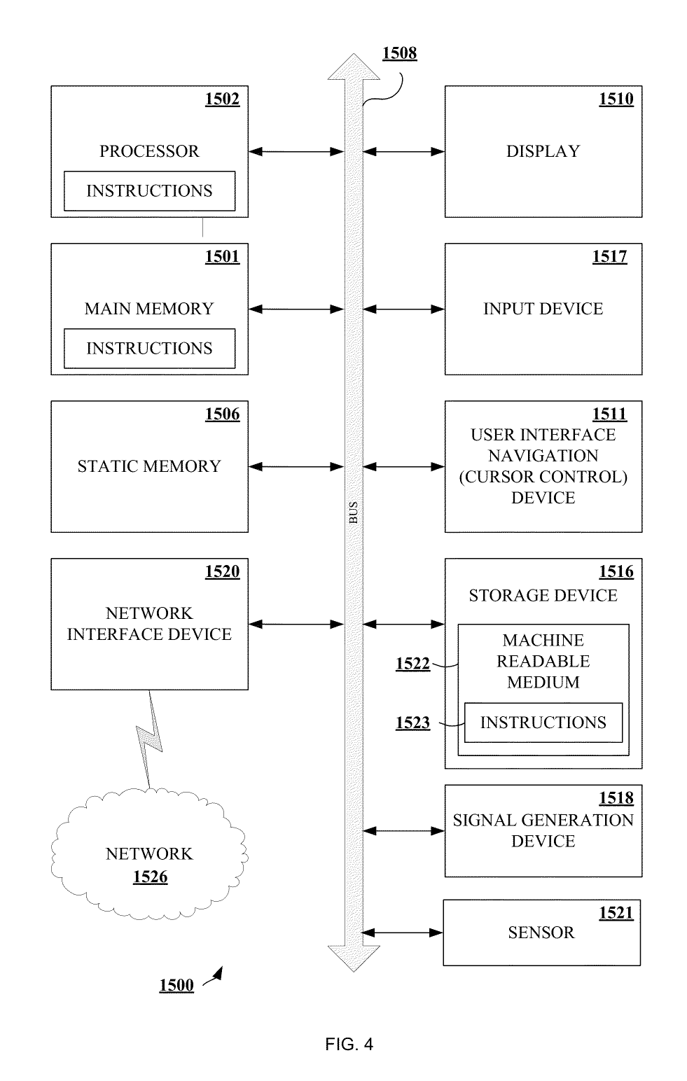

FIG. 4 is a block diagram of a machine in the form of a computer system within which a set of instructions, for causing the machine to perform any one or more of the methodologies discussed herein, may be executed. In some embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a server, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the included claims, along with the full range of equivalents to which such claims are entitled.

1. A computer-implemented method comprising:
receiving data comprising a model defining one or more model entities and one or more model services; and
generating script-based code associated with the model, by:
processing the model to generate for each model entity defined in the model a value object class having support for basic data operations and advanced data operations, the basic data operations including both getter and setter functions for data properties associated with a model entity defined by the model, and the advanced data operations including derived properties, varying properties, constraints, or styles; and
processing the model to generate for each model service a service wrapper object class, the service wrapper object class to provide runtime access to a remote service, the remote service being a web service, a remote object service, or an HTTP service.

2. The computer-implemented method of claim 1, wherein the advanced data operations include a data operation to compute, at runtime, a derived property of an instance of the value object class, the derived property being bound to at least one user interface component, which is automatically updated when a value of a derived property changes.

3. The computer-implemented method of claim 2, wherein the advanced data operations include a data operation to re-compute the derived property when it is determined that a data property impacting the value of the derived property has changed, the determination made possible by a relationship, defined in the model, between the data property and the derived property.

4. The computer-implemented method of claim 1, wherein the advanced data operations include a data operation to evaluate, at runtime, the state of a Boolean property indicating the availability state of a varying property of an instance of the value object class, and if the availability state of the Boolean property indicates the existence of a varying state of the varying property, adjusting one or more visible attributes of a user interface component bound to the varying property.

5. The computer-implemented method of claim 1, wherein the advanced data operations include a data operation to evaluate a Boolean property whose value is dependent upon evaluation of a set of constraint expressions and style validations of an instance of the value object class, the Boolean property indicating the validity state of the instance of the value object class.

6. The computer-implemented method of claim 5, wherein the value object class defines an array property containing localized constraint and validation failure messages that can be read when the state of the instance of the value object class is determined to be invalid.

7. The computer-implemented method of claim 1, wherein the advanced data operations include a data operation to evaluate a property level validation expression bound to a user interface component, such that the user interface component is automatically manipulated based on the result of the operation to evaluate the property level validation expression.

8. The computer-implemented method of claim 1, wherein the advanced data operations include a data operation to retrieve, at runtime, style information specifying user-interface-related attributes associated with a property element defined by the model.

9. The computer-implemented method of claim 1, wherein the value object class generated for each entity in the model includes at least two classes, a superclass identifying the basic data operations and advanced data operations associated with the value object class, and a metadata class defining the logic to perform the basic data operations and advanced data operations defined in the superclass.

10. The computer-implemented method of claim 1, wherein an instantiation of the service wrapper object class generated based on the model service provides support for one of three remote services including: the web service, the remote object service, or the HTTP service.

11. A processing system, comprising:
at least one processor; and
a machine-readable medium in communication with the at least one processor, the machine readable medium storing a code generator module that is executable by the at least one processor, the code generator module being executed by the at least one processor to cause operations to be performed, the operations comprising:
receiving a model defining one or more model entities and one or more model services; and
generating script-based code associated with the model, by:
processing the model to generate for each model entity defined in the model a value object class having support for basic data operations and advanced data operations, the basic data operations including both getter and setter functions for data properties associated with a model entity defined by the model, and the advanced data operations including derived properties, varying properties, constraints, or styles; and
processing the model to generate for each model service a service wrapper object class, the service wrapper object class to provide runtime access to a remote service, the remote service being a web service, a remote object service, or an HTTP service.

12. The processing system of claim 11, wherein the advanced data operations include a data operation to compute, at runtime, a derived property of an instance of the value object class, the derived property being bound to at least one user interface component, which is automatically updated when a value of a derived property changes.

13. The processing system of claim 11, wherein the advanced data operations include a data operation to re-compute the derived property when it is determined that a data property impacting the value of the derived property has changed, the determination made possible by a relationship, defined in the model, between the data property and the derived property.

14. The processing system of claim 11, wherein the advanced data operations include a data operation to evaluate, at runtime, the state of a Boolean property indicating the availability state of a varying property of an instance of the value object class, and if the availability state of the Boolean property indicates the existence of a varying state of the varying property, adjusting one or more visible attributes of a user interface component bound to the varying property.

15. The processing system of claim 11, wherein the advanced data operations include a data operation to evaluate a Boolean property whose value is dependent upon evaluation of a set of constraint expressions and style validations of an instance of the value object class, the Boolean property indicating the validity state of the instance of the value object class.

16. The processing system of claim 15, wherein the value object class defines an array property containing localized constraint and validation failure messages when the state of the instance of the value object class is determined to be invalid.

17. The processing system of claim 11, wherein the advanced data operations include a data operation to evaluate a property level validation expression bound to a user interface component, such that the user interface component is automatically manipulated based on the result of the operation to evaluate the property level validation expression.

18. The processing system of claim 11, wherein the advanced data operations include a data operation to retrieve, at runtime, style information specifying user-interface-related attributes associated with a property element defined by the model.

19. A computer-readable medium storing instructions, which, when executed by a computer, cause the computer to perform operations generate script-based code, the operations including:
receiving a model defining one or more model entities and one or more model services; and
generating script-based code associated with the model, by:
processing the model to generate for each model entity defined in the model a value object class having support for basic data operations and advanced data operations, the basic data operations including both getter and setter functions for data properties associated with a model entity defined by the model, and the advanced data operations including derived properties, varying properties, constraints, or styles; and
processing the model to generate for each model service a service wrapper object class, the service wrapper object class to provide runtime access to a remote service, the remote service being a web service, a remote object service, or an HTTP service.
